(19) United States
(12) Patent Application Publication
(10) Pub. No.: US 2024/0383777 A1
(43) Pub. Date: Nov. 21, 2024

(54) SORBENT-BASED SYSTEMS AND METHODS FOR REDUCING A CONCENTRATION OF A METAL FROM A FLUID

(71) Applicant: Element3, a dba of Lithos Industries, Inc., Fort Worth, TX (US)

(72) Inventors: Hood H. Whitson, Fort Worth, TX (US); William L. Bourcier, Livermore, CA (US)

(21) Appl. No.: 18/601,896

(22) Filed: Mar. 11, 2024

Related U.S. Application Data
(60) Provisional application No. 63/489,645, filed on Mar. 10, 2023.

(51) Int. Cl. C02F 1/28; C02F 1/24; C02F 1/40; C02F 1/44; C02F 1/48; C02F 1/52; C02F 101/20; C02F 103/36

(52) U.S. Cl. CPC C02F 1/281; C02F 1/24; C02F 1/40; C02F 1/441; C02F 1/488; C02F 1/5209; C02F 2101/203; C02F 2103/365; C02F 2209/06; C02F 2209/40

(57) ABSTRACT

Embodiments of the present disclosure may include a method for reducing a concentration of at least one metal from a volume of metal containing fluid, the method including exposing the volume of fluid to a sorbent fora contact time. In some embodiments, the exposure occurs at ambient temperature and ambient pressure. Embodiments may also include removing the produced water after the contact time elapses. Embodiments may also include rinsing the metal containing sorbent after the contact time elapses. Embodiments may also include exposing the rinsed sorbent to a reagent to produce at least one metal eluate.

### PRIORITY CLAIM

The present application claims priority under the Paris Convention Treaty (PCT) to the United States provisional utility patent application No. 63/489,645 titled SYSTEM AND METHOD FOR REDUCING A CONCENTRATION OF A METAL FROM PRODUCED WATER USING A LARGE FORMAT COMPOSITION filed on Mar. 10, 2023.

### TECHNICAL FIELD

The subject matter herein relates, generally, to large format sorbent compositions for extracting a metal from produced water, and more particularly, to such compositions in which a metal salt is incorporated within a metal oxide or metal hydroxide framework.

### BRIEF SUMMARY

Embodiments of the present disclosure may include a method for reducing a concentration of at least one metal from a volume of produced water, including exposing the volume of produced water to a sorbent for a contact time. In some embodiments, the exposure occurs at ambient temperature and ambient pressure. Embodiments may also include removing the produced water after the contact time elapses. Embodiments may also include rinsing the sorbent after the contact time elapses. Embodiments may also include exposing the rinsed sorbent to a reagent to produce at least one metal eluate.

Embodiments may also include exposing the volume of produced water to a sorbent for a contact time or may include batch processing the volume of produced water with the sorbent for the contact time. Embodiments may also include batch processing the volume of produced water with the sorbent for the contact time or may include mixing the volume of produced water with the sorbent for the contact time.

Embodiments may also include batch processing the volume of produced water with the sorbent for the contact time or may include testing a concentration level of at least one metal. Embodiments may also include batch processing the volume of produced water with the sorbent for the contact time or may include testing an indication of a concentration level of at least one metal.

Embodiments may also include testing an indication of a concentration level of at least one metal, wherein testing the indication of the concentration level includes testing the pH level of the produced water. Embodiments may also include exposing the volume of produced water to a sorbent for a contact time or may include continuous processing of the volume of produced water with the sorbent for the contact time.

Embodiments may also include continuous processing of the volume of produced water with the sorbent for the contact time or may include testing a concentration level of at least one metal. Embodiments may also include batch processing the volume of produced water with the sorbent for the contact time or may include testing an indication of a concentration level of at least one metal.

Embodiments may also include testing an indication of a concentration level of at least one metal, wherein testing the indication of the concentration level may include testing a pH level of the produced water. Embodiments may also include testing an indication of a concentration level of at least one metal, wherein testing the indication of the concentration level may include testing a flow rate of the produced water.

In some embodiments, the sorbent may be a metal-oxide sorbent. In some embodiments, the metal-oxide sorbent may be doped. In some embodiments, the metal-oxide sorbent may be doped with an ion doping agent.

In some embodiments, the metal-oxide sorbent may be a manganese oxide-based sorbent. In some embodiments, the manganese oxide-based sorbent may be doped. In some embodiments, the metal-oxide sorbent may be a manganese oxide-based sorbent that may include a lithium manganese oxide (LMO). In some embodiments, the metal-oxide sorbent may be a manganese oxide-based sorbent that may include a lithium manganese oxide (LMO)-type lithium ion-sieve (LIS).

In some embodiments, the lithium manganese oxide (LMO) may be doped. In some embodiments, the metal-oxide sorbent may be a titanate sorbent. In some embodiments, the titanate sorbent may include a lithium titanate such as Li₄Ti₅O₁₂ or Li₇TiO₁₂. In some embodiments, the titanate sorbent may be doped. In some embodiments, the titanate sorbent may be doped with at least one cation. In some embodiments, the cation may be Mg²⁺, Sn²⁺, Zn²⁺, Al³⁺, Cr³⁺, Sn⁴⁺, Zr₄₊, Ru⁴⁺, V⁵⁺, Nb⁵⁺, or the like. In some embodiments, the metal-oxide sorbent may be an aluminate sorbent such as a lithium-aluminum-layered double hydroxide chloride (LDH) sorbent such as Lix·Al₂(OH)6ClₓnH2O, where the variable x represents the Li and Cl stoichiometry, and n represents the moles of interlayer water. In some embodiments, the aluminate sorbent may be a layered double hydroxide (LDH). In some embodiments, the layered double hydroxide (LDH) refers to an undoped LiCl:Al1.5(OH)₃ or related compositions. In some embodiments, the aluminate sorbent may be doped. In some embodiments, the doped aluminate sorbent may be LiCl:Al 1.25 Fe0.25(OH)₃, also referred to as “Fe Doped LDH,” and related compounds.

In some embodiments, the contact time may be a function of at least the volume of produced water, a sorbent surface area, and a desired extraction of the concentration of metal from the volume of produced water. In some embodiments, the at least one metal may be an alkali metal. In some embodiments, the alkali metal may be lithium.

In some embodiments, the lithium from the volume of produced water may be at an initial concentration equal to or less than 100 ppm. In some embodiments, the lithium from the volume of produced water may be at an initial concentration equal to or less than or equal to 50 ppm. In some embodiments, the lithium from the volume of produced water may be at an initial concentration equal to or less than 50 ppm and greater than or equal to 3 ppm. In some embodiments, the lithium from the volume of produced water may be at an initial concentration greater than or equal to 3 ppm.

In some embodiments, the contact time may be a function of at least the volume of produced water, the mass of sorbent, and a reduction in the initial pH of the produced water to the final pH of the produced water. Embodiments may also include an initial pH of the produced water, which may be pH less than or equal to 10.0 and greater than or equal to a pH of 5.0.

Embodiments may also include a final pH of the produced water may be greater than or equal to a pH of 5.0. In some embodiments, the volume of produced water exposed to the sorbent during the contact time may be at least 30 minutes. In some embodiments, the volume of produced water exposed to the sorbent during the contact time may be at least 5 minutes. In some embodiments, the volume of produced water exposed to the sorbent during the contact time may extract the desired metal instantaneously or nearly instantaneously. In some embodiments, at least one metal from the volume of produced water may be an alkali metal.

In some embodiments, the alkali metal from the volume of produced water may be lithium. Embodiments may also include an initial concentration of lithium from the volume of produced water, wherein the initial concentration may be less than or equal to 50 ppm and greater than or equal to 10 ppm. Embodiments may also include an initial concentration of lithium from the volume of produced water, wherein the initial concentration may be greater than or equal to 10 ppm.

In some embodiments, the method may include receiving the volume of produced water. In some embodiments, the volume of produced water may be received untreated from a hydrocarbon well. In some embodiments, the method may include pre-treating the volume of produced water prior to exposing the volume of produced water to a sorbent for a contact time.

Embodiments may also include pre-treating the volume of produced water prior to exposing the volume of produced water to a sorbent for a contact time, wherein the pre-treating may include applying one or more of a mechanical filter, a chemical filter, or a magnetic separation. Embodiments may also include removing the produced water after the contact time elapses or may include treating the produced water.

Embodiments may also include removing the produced water after the contact time elapses or may include exposing the volume of produced water to a sorbent for a second contact time. Embodiments may also include removing the produced water after the contact time elapses. Embodiments may also include rinsing the sorbent after the contact time elapses. Embodiments may also include exposing the rinsed sorbent to a reagent to produce at least one metal eluate.

Embodiments may also include removing the produced water after the contact time elapses or may include exposing the volume of produced water to a second sorbent for a contact time. In some embodiments, the method may include removing the produced water after the contact time elapses. Embodiments may also include rinsing the second sorbent after the contact time. Embodiments may also include exposing the rinsed second sorbent to a reagent to produce at least one metal eluate.

Embodiments may also include rinsing the sorbent after the contact time elapses, wherein the rinsing may include rinsing the sorbent with freshwater after the contact time. In some embodiments, the method may include returning the fresh water to one or more holding tanks. In some embodiments, the method may include performing reverse osmosis on the returned fresh water.

Embodiments may also include exposing the rinsed sorbent to a reagent to produce at least one metal eluate, wherein exposing the rinsed sorbent may include exposing the rinsed sorbent to an aqueous acid solution. Embodiments may also include exposing the rinsed sorbent to an aqueous acid solution, such as an aqueous solution of hydrochloric acid (HCl).

Embodiments may also include exposing the rinsed sorbent to an aqueous solution of HCl or may include producing a metal chloride eluate. Embodiments may also produce a metal chloride eluate, such as a lithium chloride eluate. Embodiments may also include producing a lithium chloride eluate, wherein the producing the lithium chloride eluate may include removing the lithium chloride eluate from the rinsed sorbent.

Embodiments may also include exposing the rinsed sorbent to H₂SO₄ or may include producing a metal sulfate eluate. Embodiments may also include producing a metal sulfide eluate, such as a lithium sulfate eluate. Embodiments may also include producing a lithium sulfate eluate, wherein the producing the lithium sulfate eluate may include removing water from the rinsed sorbent.

In some embodiments, the method may include increasing a concentration of the eluate by removing the reagent. Embodiments may also include increasing the concentration of the eluate by removing the reagent or may include rinsing the sorbent with fresh water. In some embodiments, the method may include performing reverse osmosis on the concentrated eluate. In some embodiments, at least one of reverse osmosis or forward osmosis may produce a concentrated metal eluate and an aqueous permeate. In the case of reverse osmosis, the process yields a concentrated metal eluate and a separate stream of purified water by applying pressure to overcome the natural osmotic pressure. The concentrated metal eluate obtained from reverse osmosis comprises a metal chloride eluate.

In some embodiments, at least one of reverse osmosis or forward osmosis may result in a further concentrated metal eluate by drawing water across a semi-permeable membrane. In some embodiments, the concentrated metal eluate may include a metal chloride eluate. In some embodiments, the reverse osmosis permeate may be returned to a fresh-water tank. After the process of reverse osmosis, the permeate, which includes, or is the filtered water that has passed through the reverse-osmosis membrane, is redirected back to a freshwater tank. This practice may be employed to reuse or manage the water efficiently. The permeate from reverse osmosis is typically low in dissolved solids and contaminants, making it suitable for recycling into processes that require purified water or for direct use as fresh water, depending on the specific requirements and quality of the permeate.

In some embodiments, the method may include performing forward osmosis on the concentrated eluate. The forward osmosis process may result in a further concentrated metal eluate by drawing water across a semi-permeable membrane from the eluate into the draw solution. This process effectively separates the target solutes, concentrating the solutes in the eluate, while the draw solution becomes diluted with the transferred water. In some embodiments, the concentrated metal eluate may include a metal chloride eluate.

In some embodiments, the metal chloride eluate may include a concentrated lithium chloride eluate. In some embodiments, the method may include applying reverse osmosis to recover the fresh water. In some embodiments, reverse osmosis may increase the lithium concentration.

In some embodiments, the method may include returning the reverse osmosis permeate to a freshwater tank. In some embodiments, the method may include receiving the volume of produced water. Embodiments may also include receiving the volume of produced water or may include receiving the volume of produced water at a wellhead, a saltwater disposal well, a water recycling unit, a produced water storage facility, a retention pond, a frac pond, a flowback fluid collection site, a retention pond, a holding tank, a holding pond, a pump station, a frac tank, a desalinization unit, or a water midstream infrastructure site.

Embodiments may also include receiving the volume of produced water or may include pre-treating the produced water. Embodiments may also include receiving the volume of produced water, wherein the volume of produced water may include pre-treated produced water. Embodiments may also include pre-treating the produced water or may include running the volume of produced water through a mechanical filter.

Embodiments may also include running the volume of produced water through a mechanical filter, such as by applying at least one sock filtration, a bag filter, a polymer filtration, or a clay filtration. Embodiments may also include pre-treating the produced water such as by running the volume of produced water through a chemical filter.

Embodiments may also include pre-treating the produced water such as by applying a multiphase separator. Embodiments may also include pre-treating the produced water, such as by applying at least one of heat treatment, gravity separation, centrifugal separation, a natural media bed (e.g., nutshell filtration), a synthetic media bed, or electrochemical separation.

Embodiments may also include pre-treating the produced water such as by applying a chemical demulsifier. Embodiments may also include pre-treating the produced water such as by applying a magnetic separation treatment. Embodiments may also include pre-treating the produced water by removing an organic from the produced water.

Embodiments may also include pre-treating the produced water such as by applying at least one of a dissolved-air flotation, a suspended air flotation, a diffused air flotation, or an oxygen induced air flotation. Embodiments may also include pre-treating the produced water such as by applying an oil skimmer.

Embodiments may also include pre-treating the produced water such as by plasma treating the volume of produced water. Embodiments may also include pre-treating the produced water such as by removing at least one of a solid, oil, and H2S. Embodiments may also include pre-treating the produced water such as by precipitating an iron-containing compound.

Embodiments may also include pre-treating the produced water such as by including precipitating an iron-containing compound. Embodiments may also include pre-treating the produced water such as by adsorbing sodium. In some embodiments, the method may include receiving the volume of produced water at a weir tank. In some embodiments, at least one metal from the volume of water may be a compound containing at least one of silver, aluminum, gold, boron, beryllium, bismuth, bromine, calcium, cadmium, chromium, cobalt, or copper.

Embodiments of the present disclosure may include a method for reducing the concentration of at least one metal from a volume of produced water, the method including exposing the volume of produced water to a large format compound for a contact time. Embodiments may also include removing the produced water after the contact time elapses. Embodiments may also include rinsing the sorbent after the contact time elapses. Embodiments may also include exposing the rinsed sorbent to a reagent to produce at least one metal eluate.

In some embodiments, the method may include receiving the volume of produced water. Embodiments may also include heating the produced water to a desired temperature. In some embodiments, the method may include receiving the volume of produced water. Embodiments may also include raising the ambient pressure of the produced water to a desired pressure.

Embodiments may also include exposing the volume of produced water to a large-format composition for a contact time, such as by exposing the volume of produced water to the large-format composition using batch processing. In some embodiments, the method may include receiving the volume of produced water. Embodiments may also include heating the produced water to a desired temperature.

In some embodiments, the method may include receiving the volume of produced water. Embodiments may also include raising the ambient pressure of the produced water to a desired pressure. Embodiments may also include exposing the volume of produced water to a large-format composition for a contact time, such as by exposing the volume of produced water to the large-format composition using continuous processing.

In some embodiments, the method may include receiving the produced water. Embodiments may also include heating the produced water to a desired temperature. In some embodiments, the method may include receiving the produced water. Embodiments may also include raising the ambient pressure of the produced water to a desired pressure.

Embodiments may also include exposing the volume of produced water to a large-format composition for a contact time, or the produced water may include water that emerges from a subterranean source during the production of oil or gas. Embodiments may also include exposing the volume of produced water to a large-format composition for a contact time; the produced water may include wastewater associated with an oil and gas exploration, an oil and gas development, or an oil and gas production activity.

Embodiments may also include exposing the volume of produced water to a large-format composition for a contact time, wherein the large-format composition may include a sorbent. Embodiments may also include a sorbent, including a metal-oxide sorbent. In some embodiments, the metal-oxide sorbent may be a manganese oxide-based sorbent.

In some embodiments, the manganese oxide-based sorbent may be doped. In some embodiments, the metal-oxide sorbent may be a manganese oxide-based sorbent that may include a lithium manganese oxide (LMO). In some embodiments, the metal-oxide sorbent may be a manganese oxide-based sorbent that may include a lithium manganese oxide (LMO)-type lithium ion-sieve (LIS).

In some embodiments, the lithium manganese oxide (LMO) may be doped. In some embodiments, the lithium manganese oxide (LMO) may be Li₄Mn₅O₁₂. In some embodiments, the metal-oxide sorbent may be a titanate sorbent. In some embodiments, the titanate sorbent may be doped. In some embodiments, the metal-oxide sorbent may be an aluminate sorbent.

In some embodiments, the aluminate sorbent may be doped. In some embodiments, the at least one metal may bean alkali metal. In some embodiments, the alkali metal may be lithium. In some embodiments, the lithium from the volume of produced water may be at an initial concentration equal to or less than or equal to 100 ppm.

In some embodiments, the lithium from the volume of produced water may be at an initial concentration equal to or less than 100 ppm and greater than or equal to 3 ppm. In some embodiments, the contact time may be a function of at least the volume of produced water, the mass of sorbent, or a reduction in an initial pH of the produced water to a final pH of the produced water.

Embodiments may also include an initial pH of the produced water, wherein the initial pH may be a pH less than or equal to 10.0 and greater than or equal to a pH of 5.0. Embodiments may also include a final pH of the produced water, wherein the final pH may be greater than or equal to a pH of 5.0. In some embodiments, the method may include receiving the volume of produced water in a holding tank.

In some embodiments, the volume of produced water may be received untreated from a hydrocarbon well. In some embodiments, the method may include pre-treating the volume of produced water prior to exposing the volume of produced water to a sorbent for a contact time.

Embodiments may also include pre-treating the volume of produced water prior to exposing the volume of produced water to a sorbent for a contact time, wherein the pre-treating may include applying one or more of a mechanical filter, a chemical filter or a magnetic separation. Embodiments may also include removing the produced water after the contact time elapses, wherein the removing may further include exposing the volume of produced water to a large-format composition for a second contact time. Embodiments may also include removing the produced water after the contact time elapses. Embodiments may also include rinsing the sorbent with a rinsing agent after the contact time. Embodiments may also include exposing the rinsed sorbent to a reagent to produce at least one metal eluate.

Embodiments may also include exposing the volume of produced water to a large-format composition for a second contact time, wherein the large-format composition may include an LMO sorbent, the LMO sorbent being 250 microns in size or larger. Embodiments may also include removing the produced water after the contact time elapses, wherein the removing may include monitoring the contact time with a monitoring system.

Embodiments may also include removing the produced water after the contact time elapses, wherein the removing may include receiving an alert from the monitoring system that the contact time has elapsed. Embodiments may also include triggering a release to remove the produced water from contact with the large-format composition. Embodiments may also include removing the produced water after the contact time elapses, wherein the removing may include exposing the volume of produced water to a second large-format composition for a contact time. In some embodiments, the second large-format composition adsorbs, absorbs, or otherwise sequesters, a second metal.

In some embodiments, the method may include removing the produced water after the contact time elapses. Embodiments may also include rinsing the second sorbent with a rinsing agent after the contact time. Embodiments may also include exposing the rinsed second sorbent to a reagent to produce at least one metal eluate.

Embodiments may also include rinsing the second sorbent with a rinsing agent after the contact time, the rinsing agent may be fresh water. In some embodiments, the method may include returning the fresh water to one or more holding tanks. In some embodiments, the method may include performing reverse osmosis on the returned fresh water.

Embodiments may also include exposing the rinsed sorbent to a reagent to produce at least one metal eluate, wherein the exposing may include exposing the rinsed sorbent to an aqueous acid solution. Embodiments may also include exposing the rinsed sorbent to an aqueous acid solution, wherein the exposing may include exposing the rinsed sorbent to an aqueous solution of HCl.

Embodiments may also include exposing the rinsed sorbent to an aqueous solution of HCl, wherein the exposing may include producing a metal chloride eluate. Embodiments may also include producing a metal chloride eluate, wherein the producing may include producing a lithium chloride eluate. Embodiments may also include producing a lithium chloride eluate, wherein the producing may include removing the lithium chloride eluate from the rinsed sorbent.

In some embodiments, the method may include receiving the volume of produced water and pre-treating the volume of produced water. Embodiments may also include pre-treating the produced water, wherein the pre-treating may include running the volume of produced water through a mechanical filter. Embodiments may also include running the volume of produced water through a mechanical filter, wherein the running may include applying at least one of a cartridge filtration, a polymer filtration, or a clay filtration.

Embodiments may also include pre-treating the produced water, wherein the pre-treating may include running the volume of produced water through a chemical filter. Embodiments may also include pre-treating the produced water, wherein the pre-treating may include applying a multiphase separator. Embodiments may also include pre-treating the produced water, wherein the pre-treating may include applying at least one of heat treatment, gravity separation, centrifugal separation, nut-shell filtration, or electrochemical separation.

Embodiments may also include pre-treating the produced water, wherein the pre-treating may include applying a chemical demulsifier. Embodiments may also include pre-treating the produced water, wherein the pre-treating may include applying a magnetic separation treatment. Embodiments may also include pre-treating the produced water, wherein the pre-treating by removing an organic from the produced water.

Embodiments may also include pre-treating the produced water, wherein the pre-treating may include applying at least one of a dissolved-air flotation, a suspended-air flotation, a diffused-air flotation, or an oxygen-induced-air flotation. Embodiments may also include pre-treating the produced water, wherein the pre-treating may include applying an oil skimmer.

Embodiments may also include pre-treating the produced water, wherein the pre-treating may include plasma treating the volume of produced water. Embodiments may also include pre-treating the produced water, wherein the pre-treating may include removing at least one of a solid, oil, or H₂S. Embodiments may also include pre-treating the produced water, wherein the pre-treating may include precipitating an iron-containing compound.

Embodiments of the present disclosure may also include pre-treatment items to be removed.

In some embodiments, the method may include returning the fresh water to one or more holding tanks. Embodiments may also include a rinsing agent applied after the cycle time and may include rinsing the large-format composition with fresh water after the cycle time. In some embodiments, the method may include returning the fresh water to one or mom holding tanks. In some embodiments, the method may include performing at least one of reverse osmosis or forward osmosis on the returned fresh water.

### BRIEF DESCRIPTION OF THE FIGURES

FIG. 1 is a flowchart illustrating a method for reducing a concentration of at least one metal, according to some embodiments of the present disclosure.

FIG. 2 is a flowchart further illustrating the method for reducing a concentration of at least one metal from FIG. 1, according to some embodiments of the present disclosure.

FIG. 3 is a flowchart further illustrating the method for reducing a concentration of at least one metal from FIG. 1, according to some embodiments of the present disclosure.

FIG. 4 is a flowchart further illustrating the method for reducing a concentration of at least one metal from FIG. 1, according to some embodiments of the present disclosure.

FIG. 5 is a flowchart further illustrating the method for reducing a concentration of an at least one metal from FIG. 1, according to some embodiments of the present disclosure.

FIG. 6 is a flowchart further illustrating the method for reducing a concentration of at least one metal from FIG. 1, according to some embodiments of the present disclosure.

FIG. 7 is a flowchart further illustrating the method for reducing a concentration of at least one metal from FIG. 1, according to some embodiments of the present disclosure.

FIG. 8 is a system diagram for reducing a concentration of at least one metal from a produced water source according to some embodiments of the present disclosure.

### DETAILED DESCRIPTION

In a departure from conventional sorbent formats which are traditionally fine-grained, in some embodiments, the present disclosure describes the use of large-format compositions, often 150 microns or larger, to be used to remove metals from produced water. In some embodiments, the large-format compositions may be sorbents, spinels, or other ion-exchangers of sufficient size to support the removal of metals from produced water, and whose size facilitates the extraction of the large-format composition itself from aqueous solutions used in the process. While these large-format compositions accelerate direct-metal extraction in higher temperatures, increases in temperature and pressure common with direct extraction, adsorption, and absorption techniques are not required for removing metals from produced water.

Produced water is generally defined as any water produced concurrently with the production of oil and gas hydrocarbons from underground reservoirs or subterranean flows, including, but not limited to, naturally occurring formation water, flowback water, recycled water, or water injected into reservoirs during hydraulic fracturing or other injection methods. While produced water has been provided as an example application within the present disclosure, the present disclosure is broadly applicable to any fluid containing a metal. Nonlimiting examples of fluid containing a metal includes any fluid from a subsurface, for example brines produced from hydrocarbon reservoirs exclusively for metal extraction or as a secondary application (e.g., extracting a metal from a geothermal brine). In some embodiments, the present disclosure may be utilized to extract a metal or metals of interest from a recycle pit or other holding tank or pond on the surface.

The present disclosure is useful to existing hydrocarbon-extraction processes in several ways. The disclosure can be applied across all types of oil and gas recovery. In some embodiments, the present disclosure may be applied to primary recovery, where a well is drilled for hydrocarbon either vertically or horizontally. Upon well completion, in certain geographical areas and producing zones, natural water flow is sufficient in quantity and with viable concentrations of valuable materials for the application of large-format compositions to be used to extract metals. In some embodiments, the water may first be pre-treated, for example by using membrane systems to remove solids, colloidal silica, oil, or some heavy metals, and then fed through a skid placed on site to extract a metal of interest (e.g., lithium). For examples of metals, see “U.S. Geological Survey Releases 2022 List of Critical Minerals: U.S. Geological Survey.” U.S. Geological Survey Releases 2022 List of Critical Minerals|U.S. Geological Survey, https://www.usgs.gov/news/national-news-release/us-geological-survey-releases-2022-list-critical-minerals, incorporated herein by reference, to the extent not inconsistent herewith. In some embodiments, the process may continue in either batch or continuous flow to fully separate the materials from the produced water.

The present disclosure may similarly be applied to secondary recovery, where techniques are applied to extend the productive life of a well by injecting water or gas to displace oil and drive it to a production wellbore, resulting in the recovery of 20 to 40 percent or more of the original oil in place. In these instances, the present disclosure may be applied to the recovered produced water, thereby increasing the flow of these valuable materials. A skid or, in some embodiments, multiple skids may be placed on site to recover materials from the produced water. Lastly, in a tertiary recovery methodology, the present disclosure may be utilized to drill or recomplete/redrill and extend plugged and closed well bores that no longer produce hydrocarbons in producing and paying quantities. In this instance, once wells have been deemed insufficient for the economic recovery of oil and gas and other hydrocarbons, the present disclosure could open an entirely new resource out of abandoned well bores.

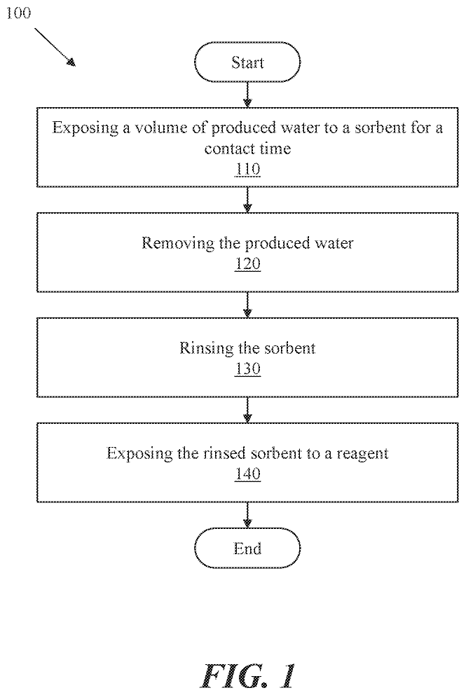

FIG. 1 is a flowchart 100, which describes a method for reducing the concentration of at least one metal according to some embodiments of the present disclosure. In some embodiments, at 110, the method for reducing a concentration of at least one metal 100 may include exposing the volume of produced water to a sorbent for a contact time. The exposure may occur at ambient temperature and ambient pressure. In some embodiments, the contact time allows the sorbent to make sufficient contact with the produced water, allowing the sorbent to sequester the metal from the produced water volume. The contact time the produced water may be placed in contact with the sorbent may vary in time based on the reactivity of the sorbent. Large-format compositions in which a metal ion may occupy a space will actively extract the metal faster as the statistical probability of a metal ion coming in contact with an unoccupied space within the large-format composition, e.g., an unoccupied space within a sorbent such as Li₄Mn₅O₁₂, is greatest when a clean, large-format composition comes in contact with the metal ion. In some embodiments, the produced water may have a reduced first contact time to quickly extract the desired concentration from the produced water. The produced water may then be transferred to a second station for batch processing, where the contact time is fine-tuned to “finish” the extraction process.

When enough time has elapsed for the metal to have been removed from the produced water such that a desired concentration of metal within the produced water has been extracted, at 120, the method may include removing the produced water from contact with the sorbent. Once a sufficient amount of produced water has been removed, at 130, the method may include rinsing the sorbent. After rinsing the sorbent at 140, the method may include exposing the rinsed sorbent to a reagent to produce at least one metal eluate.

In some embodiments, exposing the volume of produced water to a sorbent for a contact time at 110 may be accomplished by batch processing the volume of produced water with the sorbent for the contact time. In some embodiments, batch processing the volume of produced water with the sorbent for the contact time further comprises mixing the volume of produced water with the sorbent for the contact time. In some embodiments, batch processing the volume of produced water with the sorbent for the contact time further comprises testing a concentration level of at least one metal. In some embodiments, batch processing may be conducted in industrial equipment. In some embodiments, the equipment may be augmented with agitators and other mixing techniques to increase the opportunities for the sorbent to come in contact with the volume of produced water.

The contact time may be calculated, although, in some embodiments, the contact time may be based on a direct or indirect measurement of the change in metal concentration within the system. In some embodiments, batch processing the volume of produced water with the sorbent for the contact time further comprises testing an indication of a concentration level of at least one metal. In some embodiments, testing an indication of a concentration level of at least one metal includes testing a pH level of the produced water. In some embodiments, exposing the volume of produced water to a sorbent for a contact time may further comprise continuous processing of the volume of produced water with the sorbent for the contact time. Continuous processing may be monitored to ensure metal extraction occurs at the desired levels.

In some embodiments, continuous processing of the volume of produced water with the sorbent for the contact time further comprises testing a concentration level of at least one metal. In some embodiments, batch processing the volume of produced water with the sorbent for the contact time further comprises testing an indication of a concentration level of at least one metal. In some embodiments, testing an indication of a concentration level of at least one metal further comprises testing the pH level of the produced water.

In some embodiments, testing an indication of a concentration level of at least one metal further comprises testing the flow rate of the produced water. In some embodiments, the sorbent may be a metal-oxide sorbent. In some embodiments, the metal-oxide sorbent may be doped. In some embodiments, the metal-oxide sorbent may be doped with an ion doping agent.

In some embodiments, the dopant may further comprise an ion doping agent. For a nonlimiting example of an ion doping agent, see Guotai Zhang a c, et al. “Al and F Ions Co-Modified li1.6mn1.6o4 with Obviously Enhanced Li+ Adsorption Performances,” Chemical Engineering Journal, Elsevier, 5 Jul. 2022, https://www.sciencedirect.com/science/article/abs/pii/S1385894722033988; the publication is hereby incorporated in its entirety by reference.

In some embodiments, the metal-oxide sorbent may be a manganese oxide-based sorbent. In some embodiments, the manganese oxide-based sorbent may be doped. In some embodiments, the metal-oxide sorbent may be a manganese oxide-based sorbent that may further comprise a lithium manganese oxide (LMO). For a discussion of lithium manganese oxides (LMOs) in conjunction with direct lithium extraction (DLE) based on the chemistry of the produced water, see Calvo, Ernesto, (2021), “Direct Lithium Recovery from Aqueous Electrolytes with Electrochemical Ion Pumping and Lithium Intercalation,” ACS Omega, 10.1021/acsomega.1c05516; the publication is hereby incorporated in its entirety by reference. In some embodiments, the metal-oxide sorbent may be a manganese oxide-based sorbent that may further comprise a lithium manganese oxide (LMO)-type lithium ion-sieve (LIS). For more information on LMO-type LIS, see Ding Weng a 1, et al. “Introduction of Manganese Based Lithium-Ion Sieve-A Review,” Progress in Natural Science: Materials International, Elsevier, 19 Mar. 2020, https://www.sciencedirect.com/science/article/pii/S1002007119304204; the publication is hereby incorporated in its entirety by reference.

In some embodiments, the lithium manganese oxide (LMO) may be doped. In some embodiments, the metal-oxide sorbent may be a titanate sorbent. In some embodiments, the titanate sorbent may be doped. In some embodiments, the metal-oxide sorbent may be an aluminate sorbent such as LiCl·Al₂(OH)₆nH2O. In some embodiments, the aluminate sorbent may be doped. In some embodiments, the contact time may be a function of at least the volume of produced water, a sorbent surface area, and a desired extraction of the concentration of metal from the volume of produced water.

In some embodiments, at least one metal may be an alkali metal. In some embodiments, the alkali metal may be lithium. In some embodiments, the lithium from the volume of produced water may be at an initial concentration equal to or less than or equal to 50 ppm. In some embodiments, the lithium from the volume of produced water may be at an initial concentration equal to or less than 50 ppm and greater than or equal to 3 ppm.

In some embodiments, the lithium from the volume of produced water may be at an initial concentration equal to or less than 100 ppm. In some embodiments, for example in an evaporation or desalination installation, the initial concentrations of lithium may vary and lead to produced waters with concentrations between 60 ppm to 150 ppm. In some embodiments, the contact time may be a function of at least the volume of produced water, the mass of sorbent, and a reduction in an initial pH of the produced water to a final pH of the produced water. In some embodiments, an initial pH of the produced water may be a pH less than or equal to 10.0 and greater than or equal to a pH of 5.0.

In some embodiments, a final pH of the produced water may be greater than or equal to a pH of 5.0. In some embodiments, the volume of produced water may be exposed to the sorbent during a contact time of at least 30 minutes. In some embodiments, at least one metal from the volume of produced water may be an alkali metal. In some embodiments, the alkali metal from the volume of produced water may be lithium.

In some embodiments, an initial concentration of lithium from the volume of produced water may be less than or equal to 50 ppm and greater than or equal to 10 ppm. In some embodiments, an initial concentration of lithium from the volume of produced water may be greater than or equal to 10 ppm.

In some embodiments, the method may include receiving the volume of produced water. In some embodiments, the volume of produced water may be received untreated from a hydrocarbon well.

In some embodiments, the volume of produced water may be pre-treated prior to exposing the volume of produced water to a sorbent for a contact time. In some embodiments, pre-treating the volume of produced water prior to exposing the volume of produced water to a sorbent for a contact time further comprises applying to the volume of produced water one or more of a mechanical filter, a chemical filter, or a magnetic separation.

In some embodiments, rinsing the sorbent after the contact time elapses further comprises rinsing the sorbent with fresh water after the contact time. In some embodiments, the method may include returning the fresh water to one or more holding tanks. In some embodiments, the method may include performing reverse osmosis on the returned fresh water. In some embodiments, exposing the rinsed sorbent to a reagent to produce at least one metal eluate further comprises exposing the rinsed sorbent to an aqueous acid solution.

In some embodiments, exposing the rinsed sorbent to an aqueous acid solution further comprises exposing the rinsed sorbent to an aqueous solution of HCl. In some embodiments, exposing the rinsed sorbent to an aqueous solution of HCl further comprises producing a metal-chloride eluate. In some embodiments, producing a metal-chloride eluate further comprises producing a lithium-chloride eluate. In some embodiments, producing a lithium-chloride eluate further comprises removing the lithium-chloride eluate from the rinsed sorbent.

In some embodiments, the method may include receiving the volume of produced water. In some embodiments, receiving the volume of produced water further comprises receiving the volume of produced water at one or more of a wellhead, a saltwater disposal well, a produced water storage facility, a retention pond, a frac pond, a flowback fluid collection site, a retention pond, a holding tank, a holding pond, a pump station, a frac tank, or a water midstream infrastructure site.

In some embodiments, receiving the volume of produced water further comprises pre-treating the produced water. In some embodiments of receiving the volume of produced water, the volume of produced water further comprises pre-treated produced water. In some embodiments, pre-treating the produced water further comprises running the volume of produced water through a mechanical filter. In some embodiments, running the volume of produced water through a mechanical filter further comprises applying to the volume of produced water at least one of a sock filtration, a polymer filtration, or a clay filtration.

In some embodiments, pre-treating the produced water further comprises running the volume of produced water through a chemical filter. In some embodiments, pre-treating the produced water further comprises applying a multiphase separator. Pre-treating the produced water may be done by applying several filtering techniques. In some embodiments, pre-treating the produced water further comprises applying to the produced water at least one of a heat treatment, gravity separation, centrifugal separation, or electrochemical separation that may sequester metal-containing fluid from other larger compounds, offering a more concentrated volume of metal-containing fluid. Filtering may be applied for any number of reasons. For example, mechanical filtration may be advantageous in removing particulate matter from the metal-containing fluid that might otherwise interfere with or impact and diminish the adsorption properties of a large-format sorbent, such as an LMO like Li_{1.33}Mn_{1.67}O₄. In another embodiment, conventional mechanical filters, such as media beds traditionally used to polish a metal-containing fluid, such as produced water, may be selected to remove free oil droplets and suspended solids. Media beds using natural media, (e.g., nut-shell filters or sand filters), or synthetic media (e.g., fiber filters) may be advantageous when high filtration rates are desired for industrial DLE systems.

In some embodiments, pre-treating the produced water further comprises applying a chemical demulsifier. In some embodiments, pre-treating the produced water further comprises applying a magnetic separation treatment. In some embodiments, pre-treating the produced water further comprises applying at least one of a dissolved-air flotation, a suspended-air flotation, a diffused-air flotation, or an oxygen-induced-air flotation. Pre-treating the produced water may be aided by applying flocculants, coagulants, oxidizers, surfactants, viscosity modifiers, hydrogen peroxide or other biocides to the produced water as may be required to remove oils and other undesired compounds.

In some embodiments, pre-treating a volume of produced water further comprises applying an oil skimmer to the volume of produced water. In some embodiments, pre-treating the produced water may further comprise plasma treating the volume of produced water. In some embodiments, pre-treating the produced water further comprises removing at least one of a solid, oil, or H₂S from the volume of produced water. For illustrative purposes, the pre-treatment process is applied to a produced-water feed comprising no more than 26% w/w total dissolved solids (TDS), resulting in a product that contains up to 25.6% w/w lithium sulfate (LiSO4), thereby significantly enhancing the concentration of lithium salts from the initial brine composition. In some embodiments, pre-treating the produced water further comprises precipitating an iron-containing compound.

In some embodiments, pre-treating the produced water further comprises adsorbing sodium. In some embodiments, the method may include receiving the volume of produced water at a weir tank. In some embodiments, the at least one metal from the volume of water may be a compound containing an ionic form of at least one of antimony, beryllium, bromide, cobalt, gallium, indium, lithium, magnesium, manganese, platinum group metals, potash, rare earth elements, critical minerals, scandium, strontium, titanium, tungsten, or vanadium.

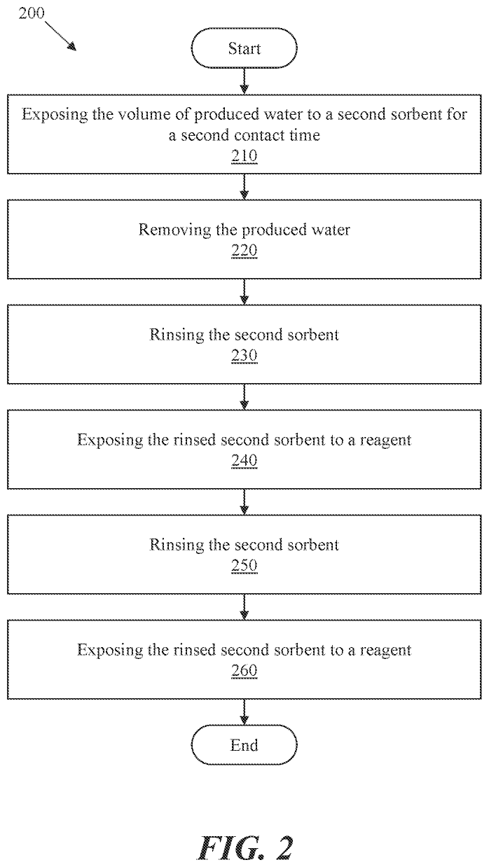

FIG. 2 is a flowchart 200 that further describes the method for reducing a concentration of at least one metal from FIG. 1, according to some embodiments of the present disclosure. In some embodiments, the produced water removed from the system described with regard to FIG. 1 may be further processed or treated to reduce the metal concentration, or the produced water may be processed to reduce the concentration of a second metal. In some embodiments, at 210, the produced water is exposed to a second sorbent for a second contact time. In some embodiments, the second contact time varies from the first contact time associated with the first sorbent. In some embodiments, at 220, the produced water is removed from the second sorbent. In some embodiments, removing the produced water after the contact time may elapse further comprises exposing the volume of produced water to a second sorbent for a contact time. At 230, the second sorbent may be rinsed to ensure the second sorbent is free of produced water.

After the second sorbent has been rinsed, at 240, the second sorbent may be exposed to a reagent to free the metal of interest from the second sorbent. In some embodiments, at 250, the method may include rinsing the second sorbent after the contact time. At 260, the method may include exposing the rinsed second sorbent to a reagent to produce at least one metal eluate.

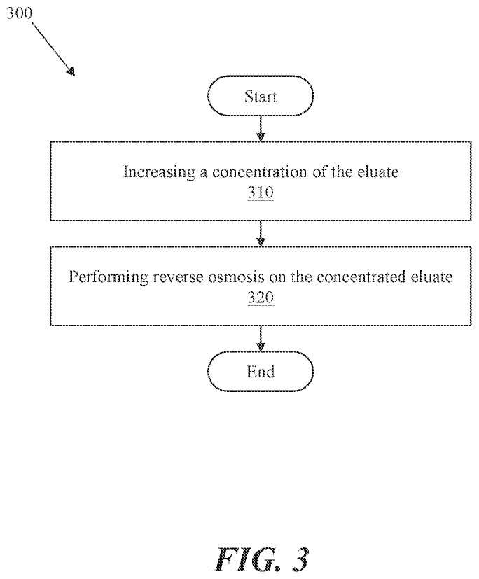

FIG. 3 is a flowchart 300 that further describes the method for reducing the concentration of at least one metal from FIG. 1, according to some embodiments of the present disclosure. In some embodiments, at 310, the method may include increasing the concentration of the eluate by removing the reagent. In some embodiments, increasing the concentration of the eluate by removing the reagent further comprises rinsing the sorbent with fresh water. In some embodiments, at 320, the method may include performing reverse osmosis on the concentrated eluate to remove the water. For reverse osmosis, the process may yield a concentrated metal eluate alongside a desalinated permeate. Following reverse osmosis, the desalinated permeate may then be recirculated to a freshwater tank for reuse, contributing to the efficient management of water resources within the system. In some embodiments, the reverse osmosis may produce a concentrated metal eluate and an aqueous permeate, where the concentrated metal eluate further comprises a metal-chloride eluate, for example, a lithium-chloride eluate.

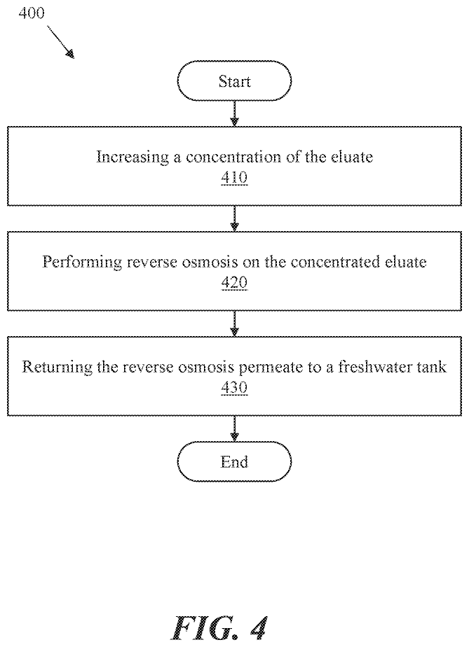

FIG. 4 is a flowchart 400 that further describes the method for reducing a concentration of at least one metal from FIG. 1, according to some embodiments of the present disclosure. In some embodiments, at 410, the method may include increasing the concentration of the eluate by removing the reagent. In some embodiments, increasing the concentration of the eluate by removing the reagent further comprises rinsing the sorbent with fresh water. In some embodiments, a forward osmosis process may be performed on the concentrated eluate, wherein the forward osmosis process yields a further concentrated metal eluate and utilizes a draw solution. This method may effectively separate the target solutes from the eluate, increasing the solute concentration in the draw solution, while the eluate itself becomes more concentrated due, at least in part, to the osmotic transfer of water. In some embodiments, at 420, the method may include performing reverse osmosis on the concentrated eluate. Reverse osmosis may produce a concentrated metal eluate and an aqueous permeate. In some embodiments, at 430, the method may include returning the reverse osmosis permeate to a freshwater tank. In some embodiments, the reverse osmosis permeate may be reused in a batch process or continuous processing system.

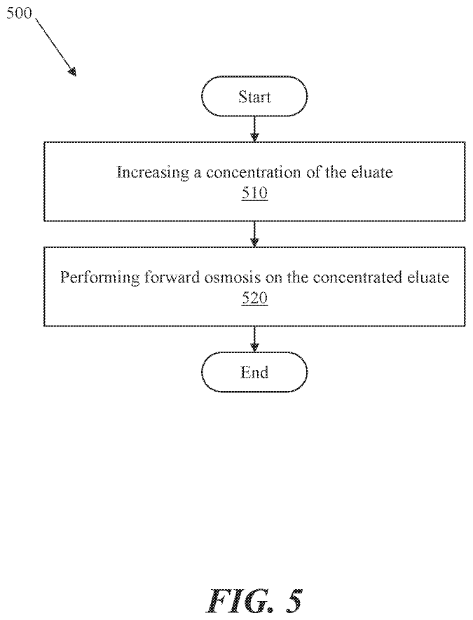

FIG. 5 is a flowchart 500 that further describes the method for reducing a concentration of at least one metal from FIG. 1, according to some embodiments of the present disclosure. In some embodiments, at 510, the method may include increasing the concentration of the eluate by removing the reagent. In some embodiments, increasing the concentration of the eluate by removing the reagent further comprises rinsing the sorbent with fresh water. In some embodiments, at 520, the method may include performing forward osmosis on the concentrated eluate. The forward osmosis can result in a further concentrated metal eluate by drawing water across a semi-permeable membrane from the eluate into the draw solution. This process effectively separates the target solutes, concentrating them in the eluate, while the draw solution becomes diluted with the transferred water. In some embodiments, the concentrated metal eluate further comprises a metal-chloride eluate. In some embodiments, the metal-chloride eluate further comprises a concentrated lithium-chloride eluate. In some embodiments, forward osmosis may increase the lithium concentration by ten times.

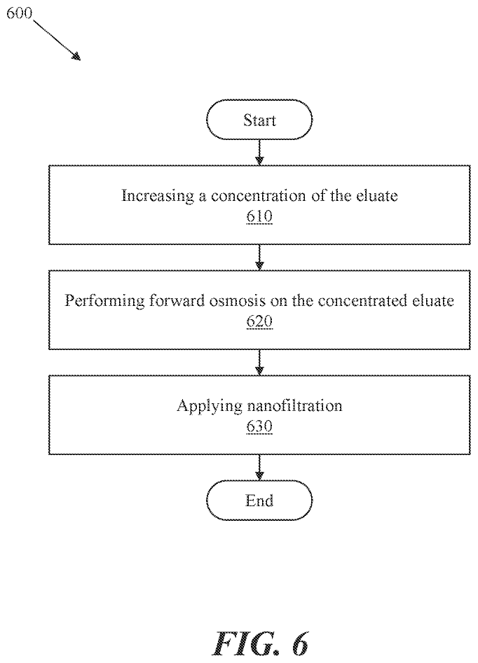

FIG. 6 is a flowchart 600 that further describes the method for reducing a concentration of at least one metal from FIG. 1, according to some embodiments of the present disclosure. In some embodiments, at 610, the method may include increasing the concentration of the eluate by removing the reagent. In some embodiments, increasing the concentration of the eluate by removing the reagent further comprises rinsing the sorbent with fresh water. In some embodiments, at 620, the method may include performing forward osmosis on the concentrated eluate. Performing forward osmosis may yield a further concentrated metal eluate utilizing a draw solution. During forward osmosis, water is drawn from the feed solution (i.e., the eluate) typically across a semi-permeable membrane towards the draw solution due to the osmotic gradient. After forward osmosis, the draw solution, which has now increased in volume and decreased in solute concentration due to the influx of water, can be treated or diluted to reduce its solute concentration back to a level suitable for reuse in the process. This method effectively separates the target solutes from the eluate, increasing the solute concentration in the draw solution, while the eluate itself becomes more concentrated due to the osmotic transfer of water.

After its osmotic-concentration gradient has facilitated water transfer through the forward-osmosis membrane, the draw solution is recirculated back to a fresh water tank for replenishment and reuse. Returning the treated or diluted draw solution to the freshwater tank may involve adjusting the concentration of the draw solution after it has facilitated water transfer in the forward-osmosis process to restore it to a suitable condition for reuse. In some embodiments, an aim can be to replenish the freshwater tank with a solution that can again create an effective osmotic gradient for the forward-osmosis process, thus continuing the cycle of concentrating the metal eluate. In some embodiments, this step may involve diluting the draw solution to its initial concentration, allowing the diluted raw solution to be effectively used again in the forward-osmosis process to concentrate the metal eluate. While the method described at 620 outlines the use of forward osmosis for concentrating the metal eluate, metal-containing fluids that require additional concentration of the metal, for example a metal salt like LiCl, can be used. In some embodiments, the concentration of the metal salt can be enhanced through industrial forward-osmosis techniques such as the Li-FO™ system developed by Forward Water.

In some embodiments, the concentrated metal eluate further comprises a metal-chloride eluate. In some embodiments, the metal-chloride eluate further comprises a concentrated lithium-chloride eluate. In some embodiments, at 630, the method may include applying nanofiltration to further refine the eluate.

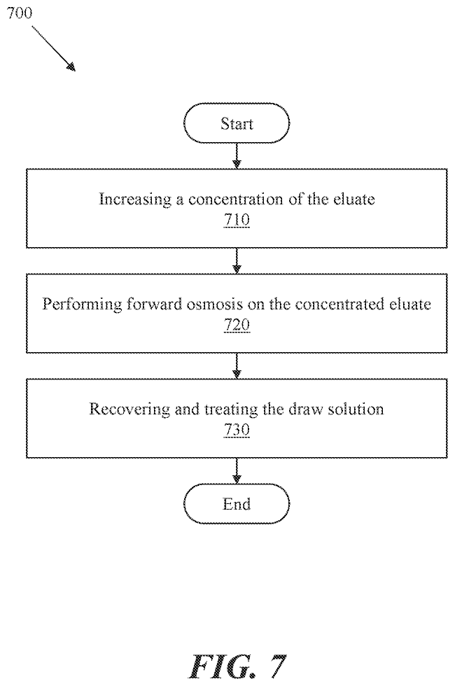

FIG. 7 is a flowchart 700 that further describes the method for reducing the concentration of at least one metal from FIG. 1, according to some embodiments of the present disclosure. In some embodiments, at 710, the method may include increasing the concentration of the eluate by removing the reagent. In some embodiments, increasing the concentration of the eluate by removing the reagent further comprises rinsing the sorbent with fresh water. In certain embodiments, at step 720, the method encompasses performing forward osmosis on the concentrated eluate. This process leverages a draw solution to create an osmotic-pressure gradient, facilitating the migration of water molecules from the concentrated eluate through a semi-permeable membrane into the draw solution. Consequently, this results in further concentration of the metal eluate. Following this, in some embodiments, at step 730, the method may involve the recuperation/recovery and treatment of the draw solution. This includes reducing the concentration of the draw solution to its original state, making it suitable for reuse in the forward-osmosis process. Subsequently, the treated draw solution is recirculated back to a freshwater tank for future applications.

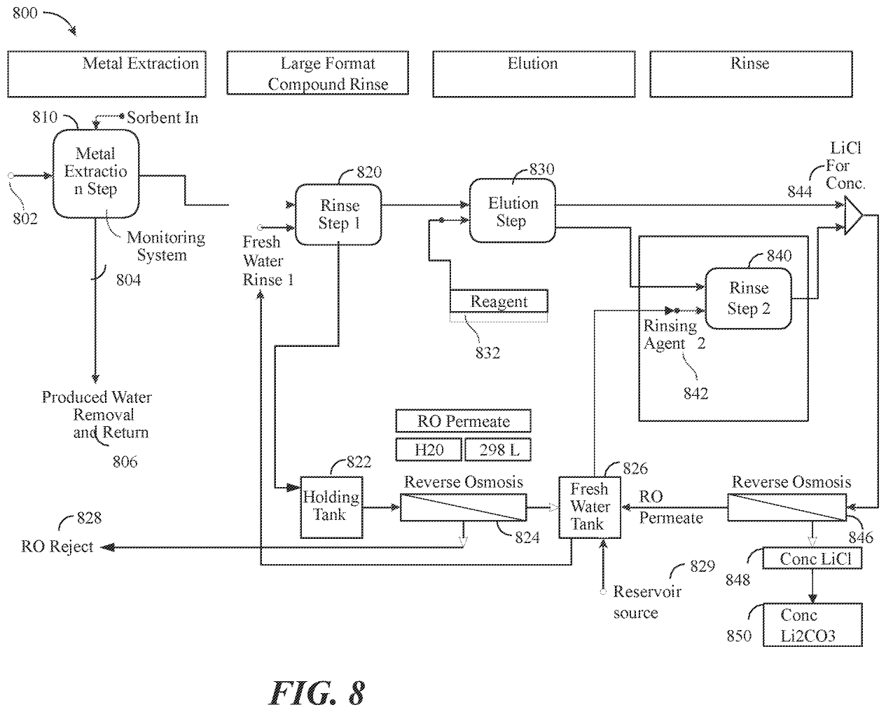

FIG. 8 is an exemplary system 800 configured to extract a desired metal from a volume of produced water, according to some embodiments of the present disclosure. For a discussion of direct lithium extraction systems, see Putro, Cahyo& Anderson, Corby (2022), INVESTIGATION OF FACTORS AFFECTING DIRECT LITHIUM EXTRACTION WITH ION EXCHANGE; hereby incorporated by reference. The system 800 depicts four phases that may be implemented to extract a metal from produced water. The first step, the metal extraction step 810, may include receiving produced water 802 into the system 800. Receiving the produced water 802 may include moving the produced water from a storage station, a shipping container, or a well using a gravity feed, a pump system, or siphon mechanism to a batch or a continuous processing system 800. Alternatively, in some embodiments, receiving the produced water 802 may include receiving the produced water from a transportation vehicle (e.g., a tanker, a rail car, etc.). In some embodiments receiving the produced water 802 may include receiving the produced water from a fixed assembly, such as a pipeline. The system 800 may be configured to process a volume of produced water measured in various volumes and may accommodate a variety of concentrations of at least one metal. Accommodating a variety of concentrations of at least one metal may be necessary when extracting metal from produced water, as the concentrations of metal diminish, sometimes predictably, over the life of a well. In some embodiments, the system may pre-process or otherwise pretreat the produced water 802 prior to the metal-extraction step 810.

In some embodiments, the metal-extraction step 810 is aided by using a large-format composition capable of extracting metals, for example, metals in ionic form within the produced water. In some embodiments, the large-format composition, for example, an LMO sorbent greater than 250 microns, may be scaled up to accommodate volumes of produced wastewater of over 10,000 barrels. The large-format composition may process more than 33,122 liters per contact with a thirty-minute contact time. The system 800 may use one or more batch-processing or continuous-processing techniques to run as many as 48 contacts prior to exhausting the large-format composition. In some embodiments, the contact time may be tuned to account for the initial concentration of metal within the produced water 802 to ensure sufficient contact with the large-format composition, e.g., an ion-exchange media, has sufficient contact time to remove the desired volume (or other units such as mass) of metal from the produced water. The metal-extraction step 810 of system 800 may be configured with a monitoring system 804 to monitor the change of metal concentration. The monitoring system 804 may be equipped with a CPU, peripheral devices such as temperature, pH, and other chemical-properties-and-contents sensors that may be used to characterize the contents and nature of the produced water. In some embodiments, the monitoring system 804 may monitor the duration of the contact time, the contact time, the volume of produced water in the system, the count of elapsed contact times, the status of equipment (e.g., the health of equipment, a maintenance status, the active or inactive status of equipment), or visual and/or audible indicators to alert a user to take action. The CPU may be connected to an internet or local network to send status updates of the system. For example, as a large-format composition, for example, a sorbent, approaches the end of its useful life, the CPU of the digital monitoring system may create an alert and transmit the alert to a user interface so the sorbent may be replenished at an appropriate time.

In some embodiments, the produced water is removed 806 from the metal extraction step 810. In some embodiments, the produced water may be actively removed using an appropriate mechanism that sequesters the large-format composition from the produced water. The produced water 806 may also be further processed to extract additional metals in a staged continuous-extraction process. In an alternative embodiment, the produced water may be transferred to another portion of the system 800 adapted to extract a second metal, pollutant, or to administer a treatment prior to returning the produced water for transport to an alternative site.

In some embodiments, the large-format composition, laden with the metal, may undergo a rinse step 820. In some embodiments, the rinse step 820 may use a rinsing agent, for example, fresh water, to remove remaining produced water from the large-format composition. In some embodiments, a freshwater rinsing agent of three hundred thirty one (331) liters may be used to ensure that the large-format composition is sufficiently free of produced water. In some embodiments, the properties of the large-format composition may be used to separate the large-format composition from the produced water in the rinse step 820. For example, removing the produced water 806 from the large-format composition, such as an LMO, may involve applying a magnetic field to use the magnetic properties of the LMO to concentrate the large-format composition for removal. In some embodiments, the rinsing step 820 may be aided by applying backpressure or a vacuum to the system. While discussed with respect to the rinse step 820, the techniques may be applied to remove the large-format composition from produced water, reagents, and any other aqueous mediums used in the system 800.

Upon completion of the rinse 820, the fresh water may be removed and stored in a holding tank 822. In some embodiments, the rinsing agent may be processed to remove pollutants prior to returning the rinsing agent to a holding tank such as the holding tank 822. In some embodiments, the holding tank 822 may be adapted to use back pressure or a vacuum. In some embodiments, the rinsing agent may be transferred to a reverse-osmosis unit 824 to remove the water for storage in a freshwater tank 826. It is important to note that the freshwater tank 826, while designated for water storage, is not limited to containing solely freshwater. In the context of the Reverse Osmosis system 846, while RO permeate is indeed transferred to tank 826, this tank may serve various operational purposes. These include, but are not limited to, acting as an empty vessel for subsequent processes, being utilized to adjust the concentration levels of the tank's contents through dilution or concentration, storing draw solutions for forward-osmosis processes, or other chemical agents necessary for the system's operation. The flexibility of tank 826's usage is integral to the adaptive and efficient management of the system's fluid resources. The RO reject 828 may be removed from the system 800 in some embodiments, highlighting the system's capability to manage waste. In some embodiments, the system 800 may include monitoring equipment 804 equipped with sensing capabilities to detect water levels in the freshwater tank 826 and the freshwater reservoir source 829 to replenish the freshwater tank 826. Additionally, the inclusion of monitoring equipment to oversee water levels in tank 826, alongside a freshwater reservoir source 829, underscores the sophisticated control and replenishment mechanisms in place to maintain optimal operational conditions within the system 800.

In some embodiments, the large-format composition containing the metal of interest is exposed to a reagent 832 in an elution step 830. In some embodiments, the reagent 832 may be an acid, for example, HCl. In an embodiment in which the metal of interest is lithium, exposure of the large-format composition to the reagent, for example, an acid like HCl, will produce LiCl, allowing the LiCl to be subsequently removed from the large-format composition. Of note, the reagent 832 may be mixed in various concentration levels. Once the metal has reacted with the reagent 832, a rinsing agent 842 may remove the desired metal from the sorbent. In some embodiments, the holding tank 822 may be adapted to use a backpressure or a vacuum to support the removal of the desired metal from the sorbent. In some embodiments, the rinsing agent 842 is fresh water. Using fresh water can allow the metal in its ionic form to be contained within the water. In some embodiments, the LiCl is concentrated within the rinsing agent. When the produced water feed contains no more than 26% w/w total dissolved solids (TDS), the concentrated lithium chloride eluate may contain up to 45.3% w/w lithium chloride. Instances in which the reagent is an acid, specifically HCL, are exemplary. For example, alternative acids may produce the desired metal eluate. Should a metal sulfate eluate be desired as a product of the reagent and desired metal, H₂SO₄ may be used as a suitable reagent to produce a metal sulfide eluate, such as a lithium sulfate eluate.

In some embodiments, the direct metal extraction process may continue by further removing water from the concentrated metal salt 844. In some embodiments, the metal salt 844 may be lithium chloride and a processing step 850 may convert the lithium chloride into lithium carbonate. In some embodiments, the processing step 850 may utilize one or more conventional techniques for processing the metal salt to an alternative metal composition. See Canadian patent number CA 3158831 A1, titled “Production of Lithium Hydroxide and Lithium Carbonate” incorporated in its entirety by reference. Such techniques produce lithium carbonate from lithium chloride, water, and a carbon source.

In some embodiments, the system 800 may be delivered on site to extract metals in ionic form from produced water. In such an embodiment, the system 800 may be placed on an easily shippable skid and placed onsite, allowing for a rapidly deployable and customizable solution for extracting metals that does not disrupt other onsite operations. In some embodiments, infrastructure, such as piping with optional valves, allows the metal containing fluid to be received at a first vessel where the metal-extraction step 810 may be performed. When batch processing is used, the first vessel for performing the metal-extraction step 810 may include a valve for releasing metal containing fluid from the first vessel once a cycle time of exposure to the large-format composition has elapsed. The skid system 800 may also contain a second vessel containing a rinsing agent plumbed to the first vessel for performing the metal-extraction step 810.

Upon releasing the metal-containing fluid from the first vessel, the rinse step 820 may be performed, allowing the fluid to be washed from the large-formation composition, such as a large-format sorbent/spinel. In some embodiments the skid system 800 may contain a third vessel plumbed to the first vessel for performing the metal extraction 810 and/or rinse step 820. The third vessel may contain a reagent. In some embodiments, the reagent stored within the third vessel is released into the first vessel to release the metal contained within the large-format composition into a fluid containing the reagent (e.g., the elution step 830). The skid system 800 may be adapted for continuous or batch processing. In some embodiments, the skid system 800 includes at least plumbing and necessary fluid storage vessels to complete a metal-extraction step 810, a rinse step 820, and an elution step 830. In some environments, a second rinse step 840 may not be needed. In some embodiments, the skid system may be adapted with a forward-osmosis system (e.g., when fresh water is plentiful) or a reverse-osmosis system 845 (e.g., when fresh water is more scarce and on-site water recovery is desired to support direct metal extraction or other on-site needs).

In some embodiments, the skid system 800 may be further adapted to on-site environmental conditions in other ways. For example, additional equipment may be co-located or otherwise installed on the skid to support the rinse step 820. A holding tank 822 may be connected to a forward-osmosis system or a reverse-osmosis system 846. In some embodiments, the forward-osmosis system or the reverse-osmosis system 846 may be plumbed to a freshwater tank 826. The freshwater tank 826 may support the rinse step 820, and/or optionally provide a water source for a second rinse step 840. While the freshwater tank 826 is depicted as serving the purpose of storing freshwater for the rinse step 820, it should be understood that system 800 may utilize the freshwater tank 826 for a variety of functions. This includes, but is not limited to, adjusting concentration levels of the contents, storing draw solutions, or serving as an intermediary in the treatment or conditioning process. Additionally, although illustrated as a single unit for simplicity, the freshwater tank 826 may be part of a more complex system comprising multiple tanks, each designed to fulfill specific roles within the overall operation, thereby enhancing the system's flexibility and efficiency in water-management-treatment processes. The nomenclature of “freshwater tank” is not intended to be limited to merely storing freshwater. In some embodiments, the reverse-osmosis unit 824 may be augmented or replaced with a filtration system (e.g., a nanofiltration system, an ultrafiltration system, or another water-filtration system such as a distillation or deionization system) to clean the rinse of the rinse step 820.

In some embodiments, the system 800 is augmented or adapted at 846 with systems for further concentrating the metal salt eluate 844. While the system 800 is depicted with a reverse-osmosis unit 846, in some embodiments the reverse-osmosis unit may be replaced with or augmented with an industrial evaporator. In an alternative embodiment in which energy sources are not plentiful, further concentrating the metal-containing eluate may be accomplished in an evaporation pond.

In some embodiments, the skid system 800 may be further adapted with equipment to convert a metal salt to an alternative chemical composition (e.g., lithium chloride to lithium carbonate).

In some embodiments, the system 800 may include valves and equipment capable of being controlled by a monitoring system 804. The monitoring system 804 may contain a CPU having instructions for requesting sensor information collected by peripheral sensors and/or devices connected to the monitoring system 804. In some embodiments, peripheral sensors may be hardwired to the monitoring system 804 or wirelessly connected to the monitoring system 804. In some embodiments, wirelessly connected peripheral sensors and/or devices directly communicate through the wireless network to the monitoring system 804 and/or communicate through a network router to a local, remote, or otherwise cloud-based monitoring system 804.

The monitoring system 804 may track or otherwise sense the chemical properties of the produced water 802, detect the amount of large-format sorbent in the metal-extraction step 810, and/or track the contact time of the produced water 802 with the large-format sorbent. In some embodiments, the sensed information may be used to automatically start pumps or open valves used remove the produced water 806.

In some embodiments, the CPU further contains instructions for initializing the rinse step 820. In some embodiments, the monitoring system 804 may initialize the rinse step 820 upon detecting the removal of the produced water to a produced water return 806. In an alternative embodiment, the monitoring system 804 may monitor the changing properties of the produced water 802 as the desired metal is extracted. For example, when lithium ions within the produced water 802 are sequestered within a large-format composition, for example a large-format spinel of LMO, the pH becomes more acidic as the lithium-ion concentration decreases in the produced water 802. Such a phenomenon, e.g., a changing property of the produced water 802, may be monitored by the monitoring system 804, and upon the changing property of the produced water 802 reaching a state indicative of an extraction level of the lithium ion, the produced water may be removed and the rinse step 820 initiated. For example, a volume of produced water containing 200 ppm levels of lithium may have an initial pH of 8.8. Upon reducing the ppm levels of lithium to roughly 13 ppm, the pH may become more acidic, achieving a pH of 6.1. In an alternative embodiment, the monitoring system 804 may contain instructions that when executed by the CPU cause a magnetic field to be applied to a container where the metal-extraction step 810 has taken place. The activation of a magnetic field benefits from the inherent magnetic properties of certain sorbents and large-format compositions. For example, the application of the magnetic field may attract a sorbent, such as an LMO spinel, to aggregate on a surface of the container when the produced-water return 806 receives a command/instruction to open.

In an embodiment in which the system 800 is placed on a mobile skid, the state information related to the metal-extraction step 810, the rinse step 820, and other activities such as the elution step 830 may be transmitted to remote users monitoring the extraction process depicted in FIG. 8.

In some embodiments, the monitoring system 804 may monitor the quality of the aqueous solution used to perform the rinse step 820. The monitoring system 804 may actively sense the presence of fluids in the system 800 such as rinsing agents, the quality of the rinsing agents, the presence of the rinsing agents, the chemical composition of the rinsing agent, or the current state of the rinsing agents as indicated by one or more of a temperature, pressure, pH, or the like. Such information may be communicated to a user, for example over a private local area network (LAN). In some embodiments, the monitoring system 804 may be adapted with an ethernet port, cellular antennae, or other wireless-communications equipment for transmitting and receiving status information to local and remote users.

In some embodiments, the monitoring system may include instructions that when executed cause the release of a reagent 832 to the rinsed sorbent containing the metal of interest. The release may activate or otherwise open a valve separating a reagent tank (not depicted) from a tank where the elution step 830 takes place. In some embodiments, the rinse step 820 and elution step 830 occur in the same tank. The monitoring system 804 may contain sensors able to monitor the molar concentration of the reagent 832. In some embodiments, the system 800 may include multiple reagents tuned to the metal sought to be extracted from the large-format composition.

In some embodiments, the monitoring system may include instructions that when executed cause the system 800 to conduct a second rinse step 840. The second rinse step 840 may be initiated by releasing a rinsing agent 842. In some embodiments, the monitoring system may include instructions that when executed cause the system 800 to release a concentrated metal salt 844 to a reverse-osmosis station 846.

In some embodiments, the monitoring system may include instructions that when executed cause the system 800 to process 850 the metal salt 848 into an alternative composition containing the metal. In some embodiments, the system 800 may use conventional techniques, for example converting a concentrated lithium chloride 848 salt to a concentrated lithium carbonate.

In some embodiments the system 800 may be fully automated, semi-autonomous, or manually operated.

A number of techniques may be used to separate the desired metal from the rinsing agent. In some embodiments, the desired metal may be removed from the aqueous solution using one or more of forward osmosis, reverse osmosis, and selectively permeable membranes.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present disclosure. Forward osmosis may operate under relatively low energy requirements compared to conventional separation processes. This advantage stems from forward osmosis's reliance on the natural osmotic-pressure gradient to drive the separation process, rather than requiring external pressure. Consequently, forward osmosis can be particularly useful in applications where energy conservation is a priority. Moreover, forward osmosis is noted for its gentle treatment of sensitive metal ions, reducing the risk of degradation or loss of quality during the separation process. This makes forward osmosis an ideal choice for recovering valuable or rare metals from dilute solutions.

Reverse osmosis, on the other hand, is highly effective for removing abroad range of contaminants, including small ions and molecules, from aqueous solutions. By applying external pressure to reverse the natural osmotic flow, reverse osmosis can achieve a high degree of purification and concentration of the metal eluate. This process is especially beneficial for applications requiring high purity levels or the concentration of metals from very dilute solutions. Additionally, reverse-osmosis systems typically can handle large volumes of fluid, making them suitable for industrial-scale operations.

The utilization of selectively permeable membranes in both forward-osmosis and reverse-osmosis processes allows for precise control over the separation of specific metals from the rinsing agent. These membranes may be tailored to selectively allow the passage of water while retaining metal ions, thereby achieving a high degree of specificity and efficiency in the separation process. The choice between forward osmosis, reverse osmosis, and selectively permeable membranes depends on the specific requirements of the metal-separation process, including desired purity levels, energy-efficiency considerations, and the scale of operation. Each method offers distinct benefits, making them valuable tools in the efficient and effective extraction of metals from aqueous solutions.

Those having ordinary skill in the art will recognize that the state of the art has progressed to the point where there is little distinction left between hardware, software, and/or firmware implementations of aspects of systems; the use of hardware, software, and/or firmware is generally a design choice representing cost vs. efficiency tradeoffs (but not always, in that in certain contexts the choice between hardware and software can become significant). Those having ordinary skill in the art will appreciate that there are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be affected, none of which is inherently superior to the other in that any vehicle to be utilized is a choice dependent upon the context in which the vehicle will be deployed and the specific concerns (e.g., speed, flexibility, or predictability) of the implementer, any of which may vary.

In some implementations described herein, logic and similar implementations may include software or other control structures suitable to operation. Electronic circuitry, for example, may manifest one or more paths of electrical current constructed and arranged to implement various logic functions as described herein. In some implementations, one or more medias are configured to bear a device-detectable implementation if such media hold or transmit a special-purpose-device instruction set operable to perform as described herein. In some variants, for example, this may manifest as an update or other modification of existing software or firmware, or of gate arrays or other programmable hardware, such as by performing a reception of or a transmission of one or more instructions in relation to one or more operations described herein. Alternatively, or additionally, in some variants, an implementation may include special-purpose hardware, software, firmware components, and/or general-purpose components executing or otherwise controlling special-purpose components. Specifications or other implementations may be transmitted by one or more instances of tangible or transitory transmission media as described herein, optionally by packet transmission or otherwise by passing through distributed media at various times.

Alternatively, or additionally, implementations may include executing a special-purpose instruction sequence or otherwise operating circuitry for enabling, triggering, coordinating, requesting, or otherwise causing one or more occurrences of any functional operations described above. In some variants, operational or other logical descriptions herein may be expressed directly as source code and compiled or otherwise expressed as an executable instruction sequence. In some contexts, for example, C++ or other code sequences can be compiled directly or otherwise implemented in high-level descriptor languages (e.g., a logic-synthesizable language, a hardware-description language, a hardware-design simulation, and/or other such similar modes of expression). Alternatively or additionally, some or all of the logical expression may be manifested as a Verilog-type hardware description or other circuitry model before physical implementation in hardware, especially for basic operations or timing-critical applications. Those skilled in the art will recognize how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those having ordinary skill in the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal-bearing medium used to actually carry out the distribution. Examples of a signal-bearing medium include, but are not limited to, the following: a recordable-type medium such as a USB drive, a solid-state memory device, a hard-disk drive, a Compact Disc (CD), a Digital Video Disk (DVD), a digital tape, a computer memory, etc.; and a transmission-type medium such as a digital- and/or an analog-communication medium (e.g., a fiber-optic cable, a waveguide, a wired communications link, a wireless communication link (e.g., transmitter, receiver, transmission logic, reception logic), etc.).

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random-access, flash, read-only, etc.)), and/or electrical circuitry forming a communications device (e.g., a modem, communications switch, optical-electrical equipment, etc.). Those having ordinary skill in the art will recognize that the subject matter described herein may be implemented in an analog or digital fashion or some combination thereof.

Those skilled in the art will recognize that at least a portion of the devices and/or processes described herein can be integrated into a data-processing system. Those having ordinary skill in the art will recognize that a data-processing system generally includes one or more of a system-unit housing, a video-display device, memory such as volatile or non-volatile memory, processors such as microprocessors or digital-signal processors, computational entities such as operating systems, drivers, graphical user interfaces, and applications programs, one or more interaction devices (e.g., a touch pad, a touch screen, an antenna), and/or control systems including feedback loops and control motors (e.g., feedback for sensing position and/or velocity, control motors for moving and/or adjusting components and/or quantities). A data-processing system may be implemented utilizing suitable commercially available components, such as those typically found in data computing/communication and/or network computing/communication systems.

In certain cases, use of a system or method as disclosed and claimed herein may occur in a territory even if components are located outside the territory. For example, in a distributed-computing context, use of a distributed-computing system may occur in a territory even though parts of the system may be located outside of the territory (e.g., relay, server, processor, signal-bearing medium, transmitting computer, or receiving computer, located outside the territory).

A sale of a system or method may likewise occur in a territory even if components of the system or method are located and/or used outside the territory.

Further, implementation of at least part of a system for performing a method in one territory does not preclude use of the system in another territory.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

One skilled in the art will recognize that the herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken to be limiting.

With respect to the use of substantially any plural and/or singular terms herein, those having ordinary skill in the art can translate from the plural to the singular or from the singular to the plural as is appropriate to the context or application. The various singular/plural permutations are not expressly set forth herein for sake of clarity.

The herein described subject matter sometimes illustrates different components contained within, or connected with, different other components. It is to be understood that such depicted architectures are presented merely as examples, and that in fact many other architectures may be implemented which achieve the same functionality. In a conceptual sense, any arrangement of components to achieve the same functionality is effectively “associated” such that the desired functionality is achieved. Therefore, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of “operably couplable” include but are not limited to physically mateable or physically interacting components, wirelessly interactable components, wirelessly interacting components, logically interacting components, or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such a recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having ordinary skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having ordinary skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented as sequences of operations, it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1.-152. (canceled)

153. A method for reducing a concentration of lithium from a volume of produced water, the method comprising:
a. exposing the volume of produced water to a sorbent contained within a mechanical filter for a contact time, wherein the exposure occurs in less than 50 degrees Celsius and less than 3 atmospheres of pressure;
b. removing the volume of produced water from the sorbent contained within the mechanical filter after the contact time elapses;
c. rinsing the sorbent contained within the mechanical filter after the contact time elapses; and
d. exposing the rinsed sorbent to a reagent to produce a lithium eluate.

154. The method of claim 153, wherein exposing the volume of produced water to a sorbent contained within a mechanical filter for a contact time further comprises batch processing the volume of produced water with the sorbent for the contact time.

155. The method of claim 154, wherein treating the produced water further comprises:
a. exposing the volume of produced water to a media bed containing the sorbent for an additional contact time;
b. removing the produced water from the media bed containing the sorbent after the contact time elapses;
c. rinsing the media bed containing the sorbent after the contact time elapses; and
d. exposing the rinsed sorbent to a reagent to produce a metal eluate.

156. The method of claim 155, wherein exposing the volume of produced water to the media bed containing the sorbent for an additional contact time further comprises exposing the volume of produced water to an additional media bed within an additional vessel filtration containing the sorbent for the additional contact time.

157. The method of claim 153, wherein treating the produced water further comprises polishing the produced water.

158. The method of claim 154, wherein mixing the volume of produced water with the sorbent for the contact time, further comprises running the volume of produced water through a media bed containing the sorbent.

159. The method of claim 158, wherein the sorbent further comprises a lithium manganese oxide (LMO), a lithium ion-sieve (LIS), a titanate sorbent, or an aluminate sorbent.

160. The method of claim 158, wherein the lithium from the volume of produced water is at an initial concentration less than 50 ppm.

161. The method of claim 159, wherein the sorbent is doped with at least one of Mg²⁺, Sn²⁺, Zn²⁺, Al³⁺, Cr³⁺, Sn⁴⁺, Zr⁴⁺, Ru⁴⁺, V⁵⁺, and Nb⁵⁺.

162. The method of claim 153, wherein exposing the volume of produced water to a sorbent contained within a mechanical filter for a contact time, further comprises continuous processing the volume of produced water through a media bed containing a sorbent.

163. The method of claim 162, wherein the sorbent further comprises a doped lithium manganese oxide (LMO).

164. The method of claim 163, wherein exposing the volume of produced water to a sorbent contained within a mechanical filter for a contact time further comprises continuous processing the volume of produced water with through the media bed containing the doped lithium manganese oxide (LMO) for the contact time.

165. A method for reducing a concentration of an at least one metal from a volume of produced water, the method comprising:
a. exposing the volume of produced water to a large-format composition within a media bed for a contact time;
b. removing the produced water from the media bed after the contact time elapses;
c. rinsing the large-format sorbent after the contact time elapses; and
d. exposing the rinsed large-format sorbent to a reagent to produce at least one metal eluate.

166. The method of claim 165, wherein exposing the volume of produced water to a large-format composition for a contact time further comprises exposing the volume of produced water to the large-format composition using batch processing.

167. The method of claim 166, wherein the volume of produced water comprises a naturally occurring water that emerges from a subterranean source during a process that at least produces a hydrocarbon by-product.

168. The method of claim 165, wherein exposing the volume of produced water to a large-format composition for a contact time further comprises exposing the volume of produced water to the large-format composition using continuous processing.

169. The method of claim 168, wherein the volume of produced water further comprises a wastewater associated with an oil and gas exploration, an oil and gas development, or an oil and gas production activity.

170. A method for reducing a concentration of an at least one metal from a volume of produced water, the method comprising:
a. exposing the volume of produced water to a large-format composition for a contact time;
b. removing the produced water from the large-format composition after the contact time elapses; and
c. rinsing the large-format composition with a reagent to produce at least one metal eluate.

171. The method of claim 170, wherein the large-format composition further comprises a lithium manganese oxide (LMO), a lithium manganese oxide (LMO)-type lithium ion-sieve (LIS), a titanate sorbent, an aluminate sorbent.

172. The method of claim 171, wherein removing the produced water after the contact time elapses further comprises:
a. exposing the volume of produced water to a large-format composition for a second contact time, wherein the large-format composition is doped with at least one of Mg²⁺, Sn²⁺, Zn²⁺, Al³⁺, Cr³⁺, Sn⁴⁺, Zr⁴⁺, Ru⁴⁺, V⁵⁺, and Nb⁵⁺;
b. removing the produced water after the contact time elapses; and
c. exposing the large-format composition to an aqueous solution of HCl or H₂SO₄ to produce at least a lithium chloride eluate or a lithium sulfate eluate.
